(19) United States
(12) Patent Application Publication
(10) Pub. No.: US 2015/0326776 A1
(43) Pub. Date: Nov. 12, 2015

(54) DYNAMICAL FOCUS ADJUSTMENT SYSTEM AND RELATED DYNAMICAL FOCUS ADJUSTMENT METHOD

(71) Applicant: Vivotek Inc., New Taipei City (TW)

(72) Inventors: Tzu-Hsiang Lin, New Taipei City (TW); Yui-Juin Liu, New Taipei City (TW); Yung-Shen Chang, New Taipei City (TW)

(21) Appl. No.: 14/705,978

(22) Filed: May 7, 2015

(30) Foreign Application Priority Data
May 12, 2014 (TW) 103116750

(51) Int. Cl. H04N 5/232; H04N 7/18

(52) U.S. Cl. CPC H04N 5/23212; H04N 5/23293; H04N 7/183

(57) ABSTRACT

A dynamical focus adjustment method is applied to a dynamical focus adjustment system. The dynamical focus adjustment method includes setting a focus area within a display window on a screen, making a first video by a first focus value when an object passes the focus area, displaying the first video on a play window of the screen, and determining whether a focus adjusting function is actuated according to an image of the first video on the play window.

### BACKGROUND OF THE INVENTION

1. Field of the Invention

The present invention relates to a dynamical focus adjustment system and a related dynamical focus adjustment method, and more particularly, to a dynamical focus adjustment system and a related dynamical focus adjustment method capable of capturing an image of a high speed object.

2. Description of the Prior Art

The monitoring camera has widespread applications and can be installed on an entrance of building, such as a factory, a dormitory, a store, a building and a residence house, or on a road where few people tread. The monitoring camera can record and store surrounding image for someday investigation or verification.

A conventional focusing procedure of the camera is executed by fixed point. While the camera is applied to vehicle license plate recognition on the highway, vehicles on the highway cannot be totally removed for the fixed point focus adjustment, and the camera cannot capture images with preferred quality of definition or resolution. For example, when the camera is disposed on a channel of the highway to monitor the vehicles, a focus value of the conventional camera cannot be adjusted to an ideal value due to continuous flow of the vehicles, and the image captured by the camera is not clear enough to recognize the vehicle license plate even if the camera catches the vehicle passing the channel. Because of the continuous flow of the vehicles on the highway, the conventional focusing procedure of the vehicle license plate recognition system is complicated and difficult to be succeeded. That is, design of a method capable of rapidly finishing dynamic focus adjustment is an important issued in the related monitor industry.

### SUMMARY OF THE INVENTION

The present invention provides a dynamical focus adjustment system and a related dynamical focus adjustment method capable of capturing an image of a high speed object for solving above drawbacks.

According to the claimed invention, a dynamical focus adjustment method includes setting a focus area within a display window on a screen, making a first video by a first focus value while an object passes the focus area, displaying the first video on a play window of the screen, and determining whether a focus adjusting function is actuated according to an image of the first video displayed on the play window.

According to the claimed invention, a dynamical focus adjustment system includes a camera, a monitor and a controller. The camera has a focus adjusting module. The monitor provides a screen. The controller is electrically connected to the camera and the monitor. The controller is adapted to drive the monitor to display information acquired by the camera on a display window of the screen, to set a focus area within the display window, to drive the camera to make a first video by a first focus value while an object passes the focus area and simultaneously drive the monitor to display the first video on a play window of the screen, and then to determine whether a focus adjusting function of the focus adjusting module is actuated according to an image of the first video on the play window.

The present invention utilizes the controller to remote control the camera, to make the video when the object passes the focus area and to display the video on the play window within the same screen, so that the user can conveniently observe the image of the video for the focus correction. As the first-made video is defocused, the present invention can show the focus area and the play window on the same screen respectively to detect whether the object passes through the focus area and to observe whether the second-made video is focused or defocused. Comparing to the prior art, the dynamical focus adjustment system and the related dynamical focus adjustment method of the present invention can effectively simplify dynamical focusing procedure, and be conveniently applied to the high-speed image recognition system for the vehicle license plate recognition on the highway.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a dynamical focus adjustment system according to an embodiment of the present invention.

FIG. 2 is a diagram of a screen according to the embodiment of the present invention.

FIG. 3 is a flow chart of a dynamical focus adjustment method according to the embodiment of the present invention.

### DETAILED DESCRIPTION

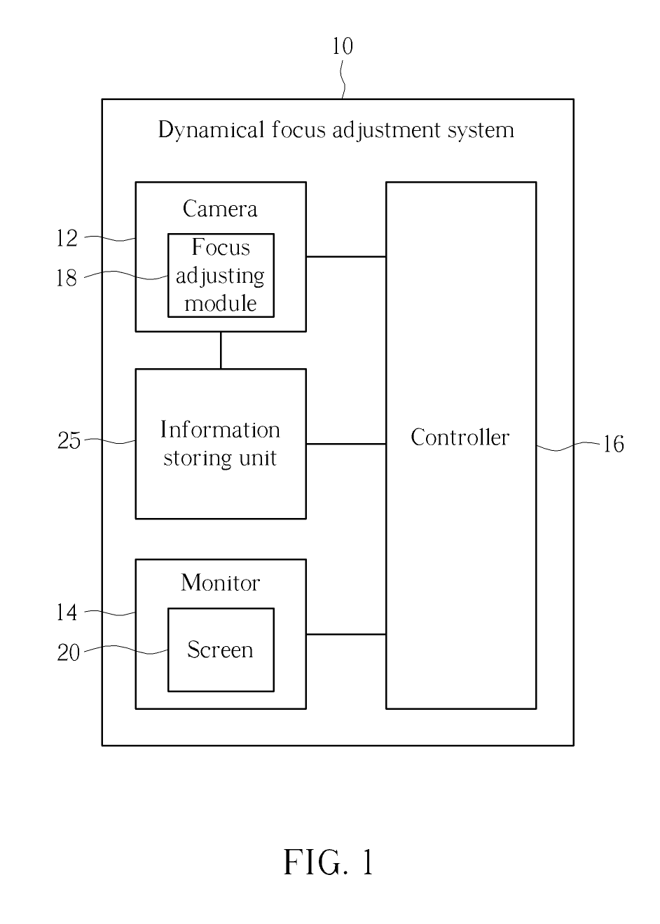

Please refer to FIG. 1. FIG. 1 is a functional block diagram of a dynamical focus adjustment system 10 according to an embodiment of the present invention. The dynamical focus adjustment system 10 includes a camera 12, a monitor 14 and a controller 16. The camera 12 is utilized to capture an image of an object which preferably can be, but not limited to, the object in high speed motion. The camera 12 has a focus adjusting module 18 to adjust a focus value of the camera 12 to increase image definition. The monitor 14 provides a screen 20 to display the image captured by the camera 12. The controller 16 is electrically connected to the camera 12 and the monitor 14. The controller 16 can be a remote controlling device by wireless/wire connection. When the object passing through a capturing range of the camera 12 is detected, the controller 16 drives the camera 12 to capture images of the capturing range by an initial predetermined focus value, make a video accordingly, and then the video is displayed on the screen 20 of the monitor 14. The video can include a plurality of continuous images, or several images captured at a specific time interval (such as five shoots per second), or a single image. Actual application of the foresaid video is not limited to the above-mentioned embodiment, which depends on design demand. A user can determine whether the image of the video is correctly focused by visual observation or software recognition, and decide whether the focus adjusting module 18 is actuated to adjust the focus value of the camera 12 for acquiring the distinct image to recognize information of the object on the image. The controller 16 of the present invention is independent from the camera 12; however, the controller 16 further can be installed inside the camera 12 in another embodiment, and the camera 12 is used to execute an image processing procedure to output a related result for the visual observation or the software recognition.

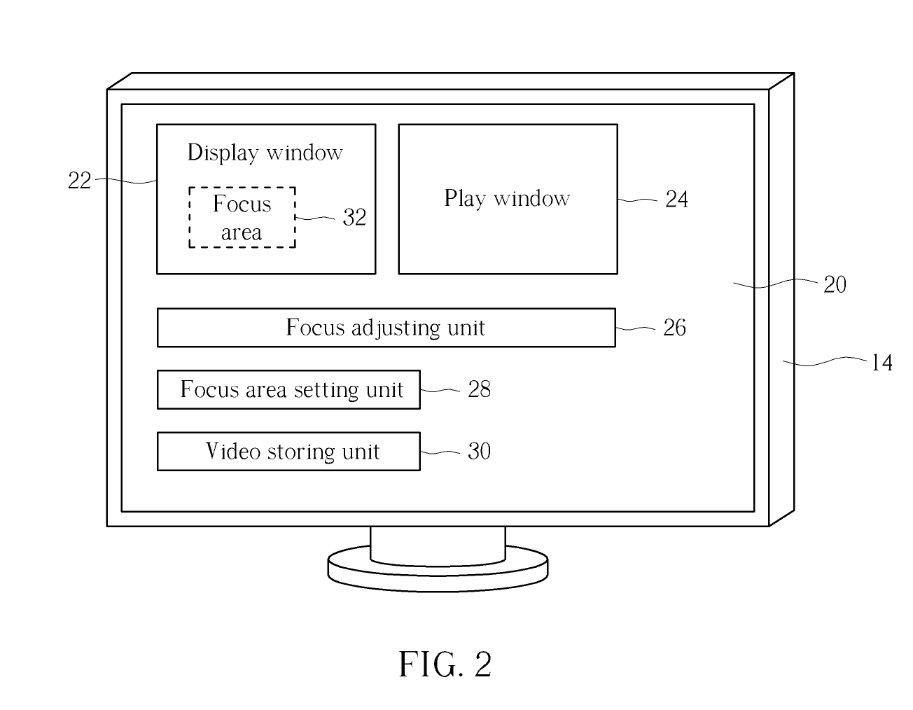

Please refer to FIG. 1 and FIG. 2. FIG. 2 is a diagram of the screen 20 according to the embodiment of the present invention. The screen 20 on the monitor 14 can include a display window 22 and a play window 24. The display window 22 is utilized to display the real time image captured by the camera 12, and the real time image is normally not stored inside an information storing unit 25 of the dynamical focus adjustment system 10, to economize storage space of the information storing unit 25. However, the real time image still can be stored inside the information storing unit 25, which depends on user's demand. The play window 24 is utilized to display the video made by the camera 12, and the video can be stored inside the information storing unit 25 according to user's decision. In this embodiment, the information storing unit 25 is independent from the camera 12 and the controller 16, but the information storing unit 25 further can be installed inside the camera 12 optionally and the controller 16 connects to the camera via a remote control interface to read information of the information storing unit 25 for displaying the video. As shown in FIG. 2, the display window 22 and the play window 24 are located on different positions of the screen 20, and the user can watch the real time image and the made video at the same time on the same screen. Besides, the display window 22 and the play window 24 can be located on the same position of the screen 20. For example, the screen 20 only shows the display window 22 while the video is not made by the camera 12, and the display window 22 is located on a predetermined position of the screen 20; as the video is finished, the screen 20 only shows the play window 24, and the play window 24 is located on the same predetermined position to completely hide the display window 22 whereon the real time image is displayed, or the play window 24 may partly cover the display window 22.

In addition, the screen 20 can have a focus adjusting unit 26, a focus area setting unit 28 and a video storing unit 30. The focus adjusting unit 26 is applied to adjust focus value of the camera 12 through the focus adjusting module 18. A focus area 32 is set within the display window 22 by the focus area setting unit 28, and dimensions of the focus area 32 can be equal to or smaller than dimensions of the display window 22. The controller 16 drives the camera 12 to make videos while the object passes the focus area 32 of the display window 22. It should be mentioned that the video can be made at an instant time point that the object just moves into the focus area 32; in another embodiment, a time period is predetermined to be an interval between the instant time point and a specific time point, so the specific time point can be calculated and the video is made at the specific time point. The specific time point is preferably, but not limited to, earlier than the instant time point, which means the video is recorded ahead of time. For example, the video can be made one second earlier than a timing that the objects passes the focus area 32, so as to prevent image missing. Length of the video is set according to actual demand, for example, the length of the video can be three seconds, and the video starts at the timing one second earlier than the object enters the focus area 32 and stops at another timing two seconds later than the object passes the focus area 32. The specific time point further can be later than the instant time point.

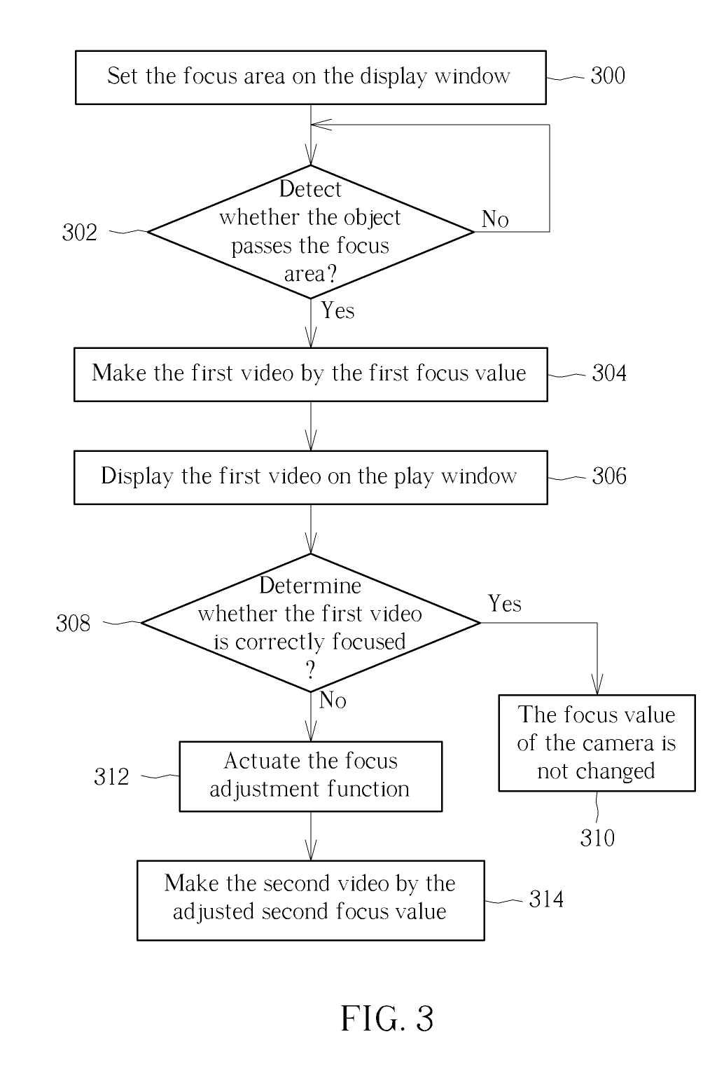

Please refer to FIG. 1 to FIG. 3. FIG. 3 is a flow chart of a dynamical focus adjustment method according to the embodiment of the present invention. The method illustrated in FIG. 3 is suitable for the dynamical focus adjustment system 10 shown in FIG. 1. First, steps 300 and 302 are executed to set a range and a position of the focus area 32 within the display window 22 by the focus area setting unit 28, so as to detect whether the object passes the focus area 32. Step 302 is repeated while there is no object passing through the focus area 32. As the object entering the focus area 32 is detected, steps 304 and 306 are executed that the camera 12 makes a first video by a first focus value (which is an initial focus value mentioned as above) and the first video is displayed on the play window 24. Then, step 308 is executed to determine whether an image of the first video displayed on the play window 24 is correctly focused. Step 310 is executed to confirm the focus value of the camera 12 when the first video is correctly focused, and the first video can be stored in the information storing unit 25 by the video storing unit 30. Steps 312 and 314 are executed to actuate focus adjusting function of the focus adjusting module 18 when the first video is not correctly focused, the camera 12 transforms its lens from the first focus value into a second focus value, and the camera 12 can make a second video by the second focus value while the object passes the focus area 32. Since the second video is finished, step 308 can be executed optionally to check whether an image of the second video displayed on the play window 24 is correctly focused, and the focus adjusting function is actuated according to the image definition of the second video.

In the present invention, a step of determining whether the video displayed on the play window 24 is correctly focused may include two solving modes. One of the solving modes utilizes an artificial visual observation to check whether the video displayed on the play window 24 is correctly focused, and the focus adjusting unit 26 on the screen 20 can be used to control the focus value of the camera via the focus adjusting module 18 when the video is defocused. The other solving mode may analyze the image of the video (such as the above-mentioned first video) by image recognition software. The image definition conforms to system requirement while one or more specific parameters of the image of the first video is greater than a threshold, and the controller 16 can directly display the video on the screen 20 without focus adjustment of the camera 12, as described in step 310. The foresaid video which has corrected focus value can be stored according to user's demand. The specific parameter can be a focus value of the image or any image parameter that is helpful for determination of focus correction. For instance, the specific parameter is the focus value acquired by image analysis, and the image is not defocused when the focus value is greater than the predetermined threshold, which represents the captured image is distinct or its definition is sufficient for recognition. In the embodiment, the controller 16 can display the full video on the screen 20, or only display the single distinct image analyzed by software, or display a plurality of images that conforms to the predetermined threshold. When the focus value is lower than the predetermined threshold, definition of the image is insufficient for actual demand, and the defocused image can be displayed or not displayed on the screen 20 of the monitor 14 optionally; meanwhile, the focus adjusting module 18 is actuated (such like step 312) to automatically adjust the focus value of the camera 12 to enhance the image definition acquired by the camera 12. In the present invention, the image recognition function can be vehicle license plate recognition function executed by software of the controller 16, which means the vehicle license plate is recognized by image analysis. Numbers of the vehicle license plate can be clearly recognized when the focus value is greater than the threshold. The numbers of the vehicle license plate is unclear when the focus value is smaller than the threshold, and the focus adjusting function is actuated to adjust the focus value of the camera 12 for the vehicle license plate recognition.

In the present invention, a step of adjusting the focus value of the camera 12 and making the video by the adjusted focus value while the object passes the focus area 32 can be repeated to optimize the dynamical focus adjustment system, for instance, the foresaid first video and the second video are made respectively by different focus values. When the controller 16 takes a plurality of videos, the controller 16 can display the most distinct image (which is generally required from the video made by the adjusted focus value) on the screen 20 through software recognition, and the adjusted focus value of the camera 12 is invariant. Or, the controller 16 can display images respectively from the plurality of videos on the screen 20, and the user picks up the most distinct image by the visual observation and then adjusts the focus value of the camera 12 corresponding to the picked image for quality enhancement of the image captured by the camera 12. Among the above-mentioned statement, steps of displaying the single distinct image on the screen 20 or displaying the plurality of images on the screen 20 side by side can be applied by a step of displaying the continuous images of the video (such as the video streaming) or a step of displaying the captured image of the video (such as the single image or the filmslide). Application of displaying one or more images on the screen 20 is not limited as mentioned above, which depends on actual demand.

The present invention utilizes the controller to remote control the camera, to make the video when the object passes the focus area and to display the video on the play window within the same screen, so that the user can conveniently observe the image of the video for the focus correction. As the first-made video is defocused, the present invention can show the focus area and the play window on the same screen respectively to detect whether the object passes through the focus area and to observe whether the second-made video is focused or defocused. Comparing to the prior art, the dynamical focus adjustment system and the related dynamical focus adjustment method of the present invention can effectively simplify dynamical focusing procedure, and be conveniently applied to the high-speed image recognition system for the vehicle license plate recognition on the highway.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dynamical focus adjustment method, comprising:
setting a focus area within a display window on a screen;
making a first video by a first focus value while an object passes the focus area;
displaying the first video on a play window of the screen; and
determining whether a focus adjusting function is actuated according to an image of the first video displayed on the play window.

2. The dynamical focus adjustment method of claim 1, wherein the display window and the play window are located on different positions of the screen.

3. The dynamical focus adjustment method of claim 1, wherein the display window is located on a predetermined position of the screen, and the play window is located on the predetermined position to hide the display window while the first video is displayed on the play window.

4. The dynamical focus adjustment method of claim 1, wherein a step of making the first video comprises: making the first video at an instant time point that the object just enters the focus area.

5. The dynamical focus adjustment method of claim 1, wherein a step of making the first video comprises:
setting a time period;
calculating a specific time point different from the instant time point that the object enters the focus area, wherein the time period is an interval between the specific time point and the instant time point; and
making the first video at the specific time point.

6. The dynamical focus adjustment method of claim 1, further comprising:
analyzing the image of the first video by an image recognition function.

7. The dynamical focus adjustment method of claim 6, wherein the image of the first video is displayed on the screen while a parameter of the image of the first video is greater than a threshold.

8. The dynamical focus adjustment method of claim 1, further comprising:
transforming the first focus value into a second focus value by the focus adjusting function; and
making a second video by the second focus value.

9. A dynamical focus adjustment system, comprising:
a camera, having a focus adjusting module;
a monitor for providing a screen; and
a controller electrically connected to the camera and the monitor, the controller being adapted to drive the monitor to display information acquired by the camera on a display window of the screen, to set a focus area within the display window, to drive the camera to make a first video by a first focus value while an object passes the focus area and simultaneously drive the monitor to display the first video on a play window of the screen, and then to determine whether a focus adjusting function of the focus adjusting module is actuated according to an image of the first video on the play window.

10. The dynamical focus adjustment system of claim 9, wherein the display window and the play window are located on different positions of the screen.

11. The dynamical focus adjustment system of claim 9, wherein the display window is located on a predetermined position of the screen, and the play window is located on the predetermined position to hide the display window while the first video is displayed on the play window.

12. The dynamical focus adjustment system of claim 9, wherein the controller makes the first video at an instant time point that the object just enters the focus area.

13. The dynamical focus adjustment system of claim 9, wherein the controller sets a time period, calculates a specific time point different from the instant time point that the time period being an interval between the instant time point and the specific time point, and makes the first video at the specific time point.

14. The dynamical focus adjustment system of claim 9, wherein the controller analyzes the image of the first video, and displays the image of the first video on the screen while a parameter of the image of the first video is greater than a threshold.

15. The dynamical focus adjustment system of claim 9, wherein the controller analyzes the image of the first video by an image recognition function.

16. The dynamical focus adjustment system of claim 9, wherein the control further transforms the first focus value into a second focus value by the focus adjusting function and makes a second video by the second focus value.
